(19) United States
(12) Patent Application Publication
(10) Pub. No.: US 2007/0014911 A1
(43) Pub. Date: Jan. 18, 2007

(54) Edible emulsion spread

(76) Inventors: Hindrik Huizinga, Vlaardingen (NL); Anton Van Immerseel, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/544,587

(22) PCT Filed: Jan. 15, 2004
(86) PCT No.: PCT/EP04/00414

§ 371 Date: Jun. 5, 2006

(30) Foreign Application Priority Data
Feb. 6, 2003 (EP) 03075358.6

(51) Int. Cl. A23D 7/00

(52) U.S. Cl. 426/602

(57) ABSTRACT

Edible water-in-oil emulsion spread comprising 25-65 wt. % oil phase and 35-75 wt. % water phase, wherein the oil phase has a tan value as defined herein of 150 s or higher, and the waterphase comprises thickener, wherein the thickener substantially consists of low amylose starch and process for the manufacture of a water-in-oil emulsion spread comprising the steps of preparing an aqueous phase and a fat phase, mixing such amounts of aqueous phase and fat phase that a pre-emulsion results which contains 25-65 wt. % of dispersed fat phase, subjecting the obtained emulsion to usual cooling and working treatments resulting in inventing the prepared pre-emulsion and finally in a plastic W/O-emulsion spread, characterized in that in preparing the aqueous phase, a low amylose starch is added.

### FIELD OF THE INVENTION

The present invention relates to reduced-fat edible water-in-oil emulsion spreads, in particular to low-fat emulsion spreads, i.e spreads having around 40 wt. % fat on product.

### BACKGROUND OF THE INVENTION

Reduced-fat edible water-in-oil emulsion spreads are well known in the art and have enjoyed considerable commercial success. It is commonplace for such emulsion spreads to have a thickened or gelled aqueous phase. Numerous components have been proposed as thickeners, including gelling polysaccharides such as carrageenan, modified starches, alginates and gelling proteins, such as gelatin. Gelatin has for long been the preferred thickener, since it has a melting point close to mouth temperature. Emulsion spreads containing gelatin consequently disperse rapidly in the mouth, releasing salt and water soluble flavour components. However, the use of animal based gelatin has become undesirable in certain cases. The primary sources of gelatin are from bovine animals and pigs. The source of gelatin can be a problem for potential areas of use or for particular consumers. Large groups around the world do not want to ingest any products of pigs (e.g., vegetarians, the Hebrews and the Muslims) or the products of beef (the Hindus and vegetarians). There is therefor a need for replacement of gelatin as a thickener.

Additionally, so called “ECO-certified food” fulfils a need of a fast growing group of consumers. In Europe, its ingredients must comply with the officially acknowledged provisions (EU regulations 2092/91) for ECO-food certification. Each ingredient must be natural which means that it has a natural origin, has been obtained by natural processes only and consequently has not been exposed to any chemical treatment whatsoever.

Some butter fat based spreads are qualified as ECO. Butter fat is not refined and generally contains up to 3 wt. % of natural emulsifiers: phospholipids and partial glycerides which have been formed by spontaneous hydrolysis of the butter fat. Therefore a spread when prepared with a dairy ingredient may be stabilised by its natural emulsifier. However, butter fat may not be preferred by some consumer, for health reasons, in particular since food with butter fat increases the risks of cardiovascular disease.

Sometimes (EP 420315, U.S. Pat No. 4591507 and EP 584835) native starches are used for thickening the aqueous phase, but always accompanied by a partial glyceride which is believed to be responsible for emulsion stability. Apparently, starches when used on their own, are not able to stabilise the emulsion.

WO 97/42829 describes a reduced fat water-in-oil spread which contains an amylose containing starch. We have found that when a slow-crystallising oil phase is used in the spreads according to WO 97/42829 using only starch as thickener and no emulsifiers, no emulsion spread can be made.

WO02/49443 describes a fat continuous spread wherein the water phase comprises a starch of which at least 50 wt.% is fully gelatinised and wherein the emulsion comprises 0.05-5 wt. % polyglycerol polyricinoleate, which is described to be a powerful emulsifier. The emulsifier is an added emulsifier, which is not natural and not ECO-certified.

In WO03/030648, not published on the priority date of the present invention, an ambient stable spread which is described, which may contain a starch chosen from the group of potato starch, tapioca starch, maize (or corn) starch and waxy maize starch. The composition of the fat phase is described to be non-critical.

We have now found that when a slow-crystallising fat blend, as defined hereinafter, is used in the spreads according to PCT patent application PCT/EP/02/10262, and in the absence of monoglyceride emulsifier, only a moderate stability of the resulting emulsions results.

A slow-crystallising oil phase is herein defined as an oil phase that shows a crystallisation rate of 150 s or lower, measured in accordance with the method described herein.

### SUMMARY OF THE INVENTION

It is an object of the invention to provide an emulsion spread comprising a slow-crystallising oil phase having an improved stability. It is another object to avoid ingredients in the emulsion spread that are not natural according to the ECO-food certification. It is a further object to provide an edible emulsion spread having good consumer characteristics, including good spreadability, melting behaviour and release of flavour and taste in the mouth. It is another object to provide an emulsion spread that is free of added emulsifier(s).

One or more of these objects are attained according to the invention, which provides an edible water-in-oil emulsion spread comprising 25-65 wt. % oil phase and 35-75 wt. % water phase, wherein the oil phase has a tau value as defined herein of 150 s or higher, and the water phase comprises thickener, characterised in that the thickener substantially consists of low amylose starch.

The according to the invention is a stable spread. A spread is considered to possess stability according to claim 1 when it passes with a score being 1 or 2 in test c. of the assessment procedure which forms part of this specification. It means that the spread remains stable for at least seven days at an ambient temperature of 15° C. and even at least ten weeks at 5° C.

The invention also comprises a manufacturing process for preparing a reduced fat spread.

### DETAILED DESCRIPTION OF THE INVENTION

All percentages in this specification are weight percentages unless indicated otherwise. Starch content is herein defined as anhydrous starch content (expressed in wt. %).

The term's ‘oil’ and ‘fat’ are used interchangeably. Percentages given are weight percentages (wt. %) on total weight of the composition, unless otherwise indicated.

“Natural” ingredients are herein defined as ingredients that have been isolated from natural sources and that have not been subjected to any modification treatment other than mechanical and/or physical treatment, exposure to heat, exposure to acid and/or exposure to bleaching agent.

Low amylose starch is herein defined as starch having an amylose content of <10 wt. % amylose. Preferably the amylose content is <5 wt. %, more preferably <1 wt. %. Amylose content of starch herein is the weight percentage (wt. %) of amylose relative to the weight of the starch, measured in accordance with the method for determining amylose content as described herein.

Preferred embodiments are described hereunder. Preferably the starch content of the emulsion spread is 1-10 wt. % on total spread, more preferably 1-5 wt. %. Advantageously the starch is waxy corn starch. Preferably the total concentration of partial glycerides in the emulsion does not exceed 0.05 wt. %. The starch may preferably be native starch, it may also be preferably be a gelatinised (pre-gelled) starch, more preferably it is a native gelatinised starch. Preferably, the spread contains only natural ingredients. Additionally, preferably the spread is obtained by natural processing.

The emulsion spread according to the invention is stable, it preferably passes with a score of 1 or 2 the emulsion stability assay as described in the specification.

The invention further relates to a process for the manufacture of an edible water-in-oil emulsion spread, which comprises the steps:
a) preparing an aqueous phase with the usual aqueous phase ingredients and a fat phase with the usual fat phase ingredients,
b) mixing such amounts of aqueous phase and fat phase that a pre-emulsion results which contains 25-65 wt. % of dispersed fat phase,
c) subjecting the obtained emulsion to usual cooling and working treatments resulting in inverting the pre-emulsion prepared in step b. and finally in a plastic W/O-emulsion spread,
   characterised in that in step a) a low amylose starch is added to the aqueous phase. Preferably the low amylose starch is a pre-gelatinised low amylose starch, more preferably a pre-gelatinised starch such as pregelatinised waxy corn starch. Even more preferably in the process solely ingredients are used which are qualified as natural.

In a preferred embodiment, the invention relates to an edible water-in-oil emulsion spread comprising 25-65 wt. % oil phase and 35-75 wt. % water phase, wherein the oil phase has a tau value as defined herein of 150 s or higher, and the water phase comprises thickener, wherein the thickener substantially consists of low amylose starch, the spread being obtainable by the a process, which comprises the steps a) b) and c) as described in the preceding paragraph and wherein in step a) a pre-gelatinised low amylose starch is added to the aqueous phase.

When native starch is used, preferably the process as described in WO03/030648 is used, the content of WO03/030648 is fully incorporated herein by reference.

An aqueous phase in which a sufficient, but relatively small amount of a thickener has been dispersed at elevated temperature becomes a thick, but pourable liquid when cooled down to ambient temperature.

Some thickeners, however, when dispersed in relatively high concentrations in a heated aqueous phase, cause the aqueous phase to become gelled when the aqueous phase cools down to ambient temperature. Such thickeners are called gelling agents, but they make gels only when applied beyond their critical concentration. When used below that concentration only a viscous liquid results. A gel is characterised in that it no longer behaves as a liquid. It retains the form of the container in which it has been formed even when it is removed from that container. Thickening agents exist in an abundant variety. Some form gels when used at elevated concentrations, others only increase viscosity, even when used in high concentrations.

In the context of the present patent a thickening agent refers to a substance increasing the viscosity of the aqueous phase in which it has been dispersed, but always for so far applied in a concentration that no gelation of the aqueous phase occurs at temperatures above 15° C.

In the context of the present invention ambient temperatures are found in the range of 15° C. and upwards. It is obvious that extremely high ambient temperatures (30° C. and more) adversely affect the emulsion stability of any spread, including the spread of the present invention. Stability at ambient temperature is meant to denote the property that no storage temperatures below 15° C. are necessary to maintain emulsion stability.

Of those thickeners natural starches and modified starches are well known ingredients for food preparation. The manufacturing processes of emulsion spreads usually employ modified, non-natural starches. When natural starches are present, without exception these starches are used without special aqueous phase treatment and together with the addition of partial glyceride, otherwise no stable emulsion results.

The present invention uses low amylose starches as thickeners for imparting emulsion stability. The presence of partial glycerides is not necessary. We have found which natural thickeners qualify for that use and which processing is needed for the preparation of a proper aqueous phase containing such thickeners.

Since partial glycerides are redundant, the invention allows the preparation of a stable ECO-grade spread with an ECO-qualified thickener, particularly with a low amylose native starch, a preferred thickener of the present invention.

A common feature of many starch thickeners which qualify for the invention is their low amylose content. These starches are unable to form a gel, at least when used in the concentrations applied for the present aqueous phase. The low amylose starches are preferably natural starches, particularly native starches, more particularly pregelatinised native starches.

Surprisingly, the spreads of the present invention in the absence of partial glycerides remain stable for at least seven days at an ambient temperature of 15° C. and, depending on the spread's composition, even for six weeks at 25° C. Preferably, the spread is prepared with solely natural ingredients. However, non-natural ingredients may be included as well.

The spread according to the present invention preferably does not contain a substantial amount of added partial glyceride. Since for emulsion stability present a spread must contain at least 0.1 wt. %, anyway at least 0.05 wt. % of partial glycerides, the content of partial glycerides in a spread according to the present invention is 0-0.1 wt. %, preferably 0-0.05 wt. %. These ranges cover small amounts of natural partial glycerides formed by fat hydrolysation. Such concentrations are not high enough for producing an ambient stable low fat spread.

An additional benefit of the invention is that expensive thickeners, such as gelatin and modified starches as used in existing aqueous phase compositions, can be substituted by a much cheaper thickener, particularly a native starch, provided, of course, the aqueous phase is prepared according to the present invention.

Preferably pre-gelatinised low amylose starch is used according to the invention. Pre-gelatinized starch is defined as starch which has been gelatinized and dried by the manufacturer before sale to the customer in a powdered form. It can be made by drum drying, spray drying or extrusion from either native or modified starch. It develops viscosity when dispersed in cold or warm water without the need for further heating. Pre-gelatinized starch is also known as precooked starch, pregelled starch, instant starch, cold water soluble starch, or cold water swelling starch (CWS). The degree of granular integrity and particle size have a major influence on their properties, e.g. dispersion and texture.

When non-pre-gelatinized (native) low amylose starch is used, the native starch should satisfy the requirements as mentioned in WO03/030648, i.e. the low amylose starch should have a peak viscosity which is at least 70 BU.

Manufacturing processes for obtaining low fat spreads starting with a fat phase and the present aqueous phase are well known to the man skilled in the art. These can be found with all details in various textbooks such as K. A. Alexandersen, Margarine Processing Plants and Equipment (Vol. 4, Bailey's Industrial Oil and Fat Products, Wiley and Sons Inc., New York 1996).

The Brabender Viscograph is the well known device for measuring temperature dependent viscosity behaviour of dispersed starches and other thickeners. The standard protocol for establishing the Brabender viscograph of a dispersion of starch or another thickening agent is specified elsewhere in this patent. From the resulting viscograph the previously mentioned peak viscosity can be read, as well as the end viscosity which is the viscosity of the thickener dispersion when cooled down to 30° C. at the end of the viscosity measurement.

Viscosities of thickener dispersions are concentration dependent. The viscograph of starches is established for an aqueous dispersion with a 3.3 wt. % starch content. The claimed viscosities at the peak temperature and the end temperature relate to starch dispersions with that concentration.

Generally, the manufacture of the invented reduced fat spreads starts with preparing a pre-emulsion, which either is fat continuous or water continuous. In the latter case the processing steps include an inversion of the initial O/W-emulsion into the desired W/O-emulsion. Processing conditions for such inversion are known from the prior art.

When native (non-gelatinised) low amylose starch is used, the inversion option, starting with an O/W-emulsion, is recommended when the end viscosity of the aqueous phase is higher than 90 BU and even essential when the end viscosity is higher than 100 BU.

The terms premix and pre-emulsion are used interchangeably and refer to the crude emulsion, also denoted as dispersion, resulting from the initial mixing of the aqueous phase with the fat phase.

The aqueous phase may be prepared by first mixing all aqueous phase ingredients including the selected thickener. For native low amylose starches i.e. that have not been pregelled, then the aqueous phase is heated up to the temperature of the thickener's peak viscosity (further denoted as “peak temperature”). Heating beyond the peak temperature causes disintegration of the swollen starch particles. Therefore, heating the aqueous phase is stopped, preferably, a few degrees centigrade below the peak temperature. Then the thickened aqueous phase is mixed with the fat phase. In case of a relatively high peak temperature the aqueous phase, before mixing, is cooled down to a suitable mixing temperature, e.g. 60° C. The obtained pre-mix is subjected to the cooling and working treatments which are usual for spread preparation.

As indicated before, the starch which is chosen for the invention is preferably a so-called pregelatinised starch. The treatment of the aqueous phase containing such starch may remains the same as for ordinary starch described before, however a heating/soaking step of the pre-gelled starch may be avoided.

Optionally, the preparation of a separate pre-mix is substituted by directly proportioning both prepared phases from their storage tanks into the first scraped surface heat exchanger (Votator A-unit).

In addition to the low amylose starch, other thickeners may be present in the aqueous phase. Suitable concentrations for some common thickeners are found in the following ranges, for starches: 2-6 wt. %, for xanthan 0.5-1.0 wt. %, for pectin 0.4-1 wt. %, for protein 3.5-10 wt. %.

Equipment, ingredients and conditions employed for carrying out the process of the invention (as far as not specified hereinbefore) are those common in spread manufacturing.

The spread according to the present invention comprises 25-65%, preferably 25-45 wt. % of fat phase. The fat of the fat phase comprises triglycerides selected from vegetable or animal sources. Such vegetable triglycerides include soybean oil, sunflower oil, palm oil, palm kernel oil, both high and low erucic rapeseed oil, coconut oil, olive oil, sesame oil, peanut oil, corn oil and mixtures thereof. Triglycerides from animal sources include fish oil, tallow and dairy fat. The fat phase usually consist of a mixture of oils and fats. Note that throughout this specification the terms oil and fat are used interchangeably. A fat which is liquid at ambient temperature usually is denoted with oil.

Usually a structuring fat, e.g. hydrogenated palm oil, forms part of the fat phase composition. In the oil phase of the present invention, which has a tau value of 150 s or higher, preferably hydrogenated oils are absent. The presence of hydrogenated oils will most likely result in a faster crystallizing oil blend, which will result in a tau value below 150. According to the invention ordinary non-natural processing such as chemical modification including hydrogenation is preferably avoided. The oil phase according to the invention may include ingredients subjected natural processing such as physical modification, fractionation and/or interesterification. Preferably, the fat contained in the present spreads consists of triglycerides from a vegetable source. Preferably, the fat qualifies as natural.

Generally, the composition of the fat in the fat phase is not critical, as long as the fat phase has a tau value as defined herein of 150 s or higher. For organoleptic reasons, it is preferred to employ fat that has a solid fat content at 35° C. of less than 5 wt. % (calculated on the weight of the fat), more preferably less than 3 wt. %. For good spreading the solid fat content at 20° C. is suitably between 5 and 30 wt. %, preferably between 5 and 20 wt. %. At 5° C. the solid fat content suitably is between 5 and 50 wt. %, preferably between 10 and 40 wt. %. The solid fat content (N-value) indicates the amount of fat present in the solid state and is expressed as a weight percentage on total fat. The N-value can be determined conveniently by the method as described in Fette, Seifen, Anstrichmittel, 80 (1978), 180-186.

Specifically, the composition of the fat depends on the desired consistency of the final product, which is either a stick, a hard tub or a soft tub spread.

Optimum organoleptic characteristics (quick oral breakdown of emulsion, absence of waxy mouthfeel) are obtained when the fat phase completely melts in the range 20°-45° C., more preferably 30°-37° C.

For cooling and working the premix is conducted according to prior art methods through a sequence of scraped surface heat exchangers (A-units) and at least one pin stirrer (C-unit). Preferably the premix is conducted through an A1-A2-A3-C sequence of three scraped surface heat exchangers and a pin stirrer. For the non-inversion process suitable exit temperatures after the A-units (shaft speeds 800 rpm) are successively: (ex A1)25±2° C., (ex A2)18±2° C., (ex A3) 9±2° C. A suitable small scale pin stirrer has a volume of 3 liters, the stirrer speed being in the range of 150-600 rpm and typically is 250 rpm. For the inversion process suitable exit temperatures after the A-units (shaft speeds 800 rpm) are successively: (ex A1) 20±2° C., (ex A2) 12±2° C., (ex A3) 7±2° C. The pin stirrer, where the inversion step takes place, is a high speed pin stirrer, preferably with a shaft speed of about 800 rpm.

Optional spread ingredients are flavouring agents, lactose, salt, preservatives, acidifiers, vitamins, and colouring agents. The compositions may comprise dairy ingredients, such as proteins, which can be derived from any dairy source. The spread is given a pH in the range 3 to 10, preferably 3.5 to 5.5, with a suitable acidifier such as lactic acid or citric acid.

The invention is illustrated by the following examples.

Assessment of Emulsion Stability

Emulsion stability is assessed by an assay which is commonly used for establishing spread stability and which consists of vigorous spreading product samples on thick paper. The samples a., b. and c. are collected after storage of the spread samples for
a. 1 week at 5° C.,
b. 10 weeks at 5° C.,
c. 1 week at 1 5° C., then storage for 2 days at 20° C. and finally, storage for 1 day at 10° C. (temperature cycling).

The assay uses the following scores:
1: excellent spreading: no softening during spreading
2: good spreading: products may be softer after spreading
3: moderate spreading: products shows visible oil or water droplets after spreading
4: unacceptable spreading: products shows large water or oil droplets
5: product is completely destroyed

Spreads are considered ambient stable according to claim 1 when they pass at least test c. with a score being 1 or 2.

Brabender Viscograph Protocol

The Brabender Viscograph is a device for viscosity measurements which has been a de facto standard in the starch industry for half a century.

For producing a graph of viscosity values, the “viscograph”, the device measures a slurry of 15 grams (about 3 wt. %) of a starch (or of any other thickening or gelling agent under consideration) suspended in 450 g of water. The rotating spindle of the Viscograph is fully covered with the starch slurry. The temperature of the slurry is raised gradually and the viscosity is continuously measured until the end of the heating regime described below. The viscosity values (Brabender units) are plotted against the temperature resulting in a viscograph.

The heating regime of the viscograph measuring protocol comprises heating the slurry starting at 45° C. and up to 90° C. at a constant rate of 1.5° C./minute. That temperature is maintained for 15 minutes, followed by cooling the slurry down to 30° C. at a cooling rate of 1.5° C./minute. The measurement is concluded by keeping the temperature at 30° C. for 15 minutes.

It appears that the viscograph of an aqueous phases only is suited for the present invention when it goes through a maximum when the temperature increases. That maximum is denoted as the “peak viscosity” and the temperature at which it is attained is denoted as the “gelatinisation temperature”. The viscosity measured at the end of the 105 minutes period is the so called “end viscosity”. The values of the peak viscosity and the end viscosity must fit into the claimed ranges. The gelatinisation temperature has to be attended when preparing the aqueous phase for the spread manufacture.

Viscosity measurements were done using this protocol for several starches described in table 1.

TABLE 1
Viscosity measurements

| | | Peak | Peak | End |
|---|---|---|---|---|
| | Conc. | Visc. | Temp. | Visc. |
| Type | (wt. %) | (BU) | (° C.) | (BU) |
| Waxy rice starch | 3.3 | 13 | 82 | 23 |
| Rice starch | 3.3 | 29 | 90 | 46 |
| Pregelled waxy maize C*HiForm | 3.3 | 5 | No peak | 18 |
| Pregelled waxy maize Xpand R612 | 3.3 | 4 | No peak | 17 |

Crystallisation Rate Measurement

The crystallisation rate is herein expressed in a tau value (in s) defined as follows. The half-time of crystallisation (tau) was determined with isothermal crystallisation using the following experimental procedure. The molten fat blend was drawn from a 100 g premix vessel and conducted through a microvotator A-unit (surface-scraping heat exchanger) operating at a throughput of about 10 kg/hr (2.78 g/s). A-units are commonly employed for (super)cooling fat blends and emulsions in spreads manufacture. Subsequent to passage through the A-unit, non-further processed fat blend was remelted in a small tube heat exchanger and recycled into the premix vessel. This cycling system provided a continuous supply of supercooled fat from the A-unit.

For measurement a sample was drawn from the A-unit into an NMR- tube. The tube was placed into a thermostated pulse NMR measuring equipment and measurements of solids content were taken at 5-15 second intervals under the supervision of a computer program (in BASIC on Hewlett Packard 200-300 series computer). Tests showed that during crystallization the sample temperature in the NMR tube remained constant at 10 degrees C. within 0.5 degrees C. The solids/time curve was used to determine the half-time for crystallization. The resulting data for the oil phases of the examples are described below.

Amylose Content

Amylose content of an emulsion spread may be measured with techniques known to the skilled person, for instance by determination titration using iodine salts. Data supplied by starch suppliers are given in table 2. Low amylose content is herein <10 wt. %, preferably <5 wt. %, more preferably <1 wt. %.

TABLE 2
Amylose content and amylopectin content of starches

| | Amylose | |
|---|---|---|
| | content | Amylopectine |
| Type | (wt. %) | content (wt. %) |
| Potato starch | 24 | 76 |
| Tapioca starch | 13 | 87 |
| Rice starch | 15 | 85 |
| Waxy rice starch | <5 | >95 |
| Waxy maize starch | <1 | >95 |
| Waxy maize starch | <1 | >95 |
| (Meritena 300) | | |
| Pregelled waxy | <1 | >95 |
| maize starch (C*HiForm) | | |
| Pregelled waxy | <1 | >95 |
| maize starch (Xpand | | |
| R612) | | |

### EXAMPLES

### Examples 1-4

Spread Preparation using Inversion Process

The compositions are given in table 3. For cooling and working the pre-emulsion of the phases is conducted through an A1-A2-A3-C sequence of three scraped surface heat exchangers and a pin stirrer. Suitable exit temperatures after the A-units (shaft speeds 800 rpm) are successively: (ex A1) 20±2° C., (ex A2) 12±2° C., (ex A3) 7±2° C. The high speed pin stirrer, where the inversion step takes place, has a shaft speed of about 800 rpm. All samples were successfully obtained by the inversion process.

The starch inclusion level was 2-3 wt. % in case of pre-gelled starch and 3 wt. % in case of native starch. An oil phase was used (83 wt. % Rapeseed oil, 17 wt. % of an interesterified blend of mid fraction of palm oil stearin and palmkernel oil) having a tau value of 250 s. The composition of the emulsion spreads is described in table 1 as well as the product stability.

TABLE 3
Composition and results of examples 1-4 and comparative
experiments A and B, fatblend has tau = 250 s

| | Example/Comparative experiment | | | | | |
|---|---|---|---|---|---|---|
| | 1 | 2 | 3 | 4 | A | B |
| Fat | 37.616 | 37.616 | 37.616 | 37.616 | 37.616 | 37.616 |
| Dimodan RT (Ex Danisco) | 0.3 | 0.3 | 0.3 | 0.3 | 0.3 | 0.3 |
| Flavour | 0.004 | 0.004 | 0.004 | 0.004 | 0.004 | 0.004 |
| Colour(1% b-carotene) | 0.08 | 0.08 | 0.008 | 0.008 | 0.008 | 0.008 |
| Water | 58.250 | 57.250 | 57.250 | 57.250 | 57.250 | 57.250 |
| Butter milk powder | 0.1 | 0.1 | 0.1 | 0.1 | 0.1 | 0.1 |
| Salt | 1.65 | 1.65 | 1.65 | 1.65 | 1.65 | 1.65 |
| Native starch | | | | | | |
| Meritena 300 ex Amylum | | | 3 | 3 | | |
| Tapioca starch | | | | | 3 | |
| Potato starch | | | | | | 3 |
| Pregelled starch: | | | | | | |
| C*HiForm ex Cerestar | 2 | | | | | |
| X pand R 612 ex Amylum | | 3 | | | | |
| Product stability | | | | | | |
| Constant at 5° C. | 1 | 1 | 1 | 1 | 4 | 3 |
| Cycling between 5 and 20° C. | 1 | 1-2 | 4-5 | 4-5 | 4-5 | 4-5 |

Table 3 shows that with a slow crystallizing fat blend (tau=250 s) stable product cannot be prepared, unless a low amylose starch is used. When a pregelled low amylose starch is used, additionally the properties of the spreads in cycling are improved.

### Examples 5-8

Examples 5-8 were executed as examples 1-4, but a fast crystallizing oil phase was used, having a tau value of 90 s. The fat blend in the oil phase consisted of 85 wt. % rapeseed oil and 15 wt. % interesterified of fully hardened palm oil and fully hardened palm kernel oil).

TABLE 4
Composition and results of examples 5-8, fatblend has tau = 90 s

| | Example/Comparative experiment | | | | | |
|---|---|---|---|---|---|---|
| | 5 | 6 | 7 | 8 | B | C |
| Fat | 37.616 | 37.616 | 37.616 | 37.616 | 38.000 | 38.000 |
| Dimodan RT (Ex Danisco) | 0.3 | | 0.3 | | | |
| Lecithin | | | | | 0.10 | 0.10 |
| Flavour | 0.004 | 0.004 | 0.004 | 0.004 | | |
| Colour(1% b-carotene) | 0.08 | 0.08 | 0.008 | 0.008 | | |
| Water | 58.250 | 58.250 | 57.250 | 57.250 | 60.4 | 60.4 |
| Skimmed milk powder | | | | | 0.4 | 0.4 |
| Sour whey powder | 0.1 | 0.1 | 0.1 | 0.1 | | |
| Salt | 1.65 | 1.65 | 1.65 | 1.65 | 1.00 | 1.00 |
| Native starch | | | | | | |
| Meritena 300 ex Amylum | | | 3 | 3 | | |
| Rice starch | | | | | | 3 |
| Waxy rice starch | | | | | 3 | |
| Pregelled starch: | | | | | | |
| C*HiForm ex Cerestar | | | | | | |
| X pand R 612 ex Amylum | 2 | 2 | | | | |
| Product stability | | | | | | |
| Constant at 5° C. | 1 | 1 | 1 | 1 | 3 | 4 |
| Cycling between 5 and 20° C. | 1 | 1 | 1 | 1-2 | 5 | 5 |

Samples B and C failed to pass the spreading tests, as could be expected, since their peak viscosity values are 13 and 29 respectively. They do not have a peak viscosity which is at least 70 BU in accordance with WO03/030648. Examples 5-8 show that the low amylose starch may also suitably to be used (outside the scope of this invention) with fast crystallising oil phases.

### Examples 9-12

Examples 9-12 were executed as examples 1-4, but a faster crystallizing oil phase was used, having a medium tau value of 160 s. The fat blend in the oil phase consisted of 45 wt. % rapeseed oil and 55 wt. % interesterified mixture of palm oil stearin, rapeseed oil and palmkernel oil, having a tau value of 160 s.

TABLE 5
Composition and results of examples 9-12, fatblend has tau = 160 s

| | Example/ | | | |
|---|---|---|---|---|
| | Comparative experiment | | | |
| | 9 | 10 | 11 | 12 |
| Fat | 39.616 | 39.616 | 39.616 | 39.616 |
| Dimodan RT (Ex Danisco) | 0.3 | | 0.3 | |
| Flavour | 0.004 | 0.004 | 0.004 | 0.004 |
| Colour(1% b-carotene) | 0.08 | 0.08 | 0.008 | 0.008 |
| Water | 57.250 | 57.250 | 57.250 | 57.250 |
| Skimmed milk powder | 0.1 | 0.1 | 0.1 | 0.1 |
| Salt | 1.65 | 1.65 | 1.65 | 1.65 |
| Native starch | | | | |
| Meritena 300 ex Amylum | | | 3 | 3 |
| Pregelled starch: | | | | |
| C*HiForm ex Cerestar | | | | |
| Xpand R 612 ex Amylum | 3 | 3 | | |
| Product stability | | | | |
| constant at 5° C. | 1 | 1 | 1 | 1 |
| cycling between 5 and | 1 | 1 | 3 | 5 |
| 20° C. | | | | |

Examples 9 and 10 show the preference for pregelled low amylose starch and examples 10 and 12 show that without partial diglycerides good spreads can be made.

1. Edible water-in-oil emulsion spread comprising 25-65 wt. % oil phase and 35-75 wt. % water phase, wherein the oil phase has a tau value as defined herein of 150 s or higher, and the water phase comprises thickener, characterised in that the thickener substantially consists of low amylose starch.

2. Emulsion according to claim 1, wherein the starch content of the emulsion is 1-5 wt. %.

3. Spread according to claim 1, wherein the starch is waxy corn starch.

4. Spread according to claim 1, wherein the total concentration of partial glycerides in the emulsion does not exceed 0.05 wt. %.

5. Spread according to claim 1, wherein starch is native starch.

6. Spread according to claim 1, wherein the spread contains only natural ingredients.

7. Spread according to claim 6, wherein the spread is obtained by natural processing.

8. Spread according to claim 1, wherein the spread passes with a score of 1 or 2 the emulsion stability assay as described in the specification.

9. Process for the manufacture of an edible water-in-oil emulsion spread, which comprises the steps:
a) preparing an aqueous phase with the usual aqueous phase ingredients and a fat phase with the usual fat phase ingredients,
b) mixing such amounts of aqueous phase and fat phase that a pre-emulsion results which contains 25-65 wt. % of dispersed fat phase,
c) subjecting the obtained emulsion to usual cooling and working treatments resulting in inverting the pre-emulsion prepared in step b. and finally in a plastic W/O-emulsion spread,
characterised in that in step a) a low amylose starch is added to the aqueous phase.

10. Process according to claim 9, wherein the low amylose starch is a pre-gelatinised low-amylose starch.

11. Process according to claim 9, wherein the starch is a waxy corn starch.

12. Process according to claim 9, wherein solely ingredients are used which are qualified as natural.
